(19) United States
(12) Patent Application Publication
(10) Pub. No.: US 2017/0247238 A1
(43) Pub. Date: Aug. 31, 2017

(54) HYDRAULIC CIRCUIT FOR FORKLIFT

(71) Applicant: DOOSAN CORPORATION, Seoul (KR)

(72) Inventor: Byung Kwon LEE, Incheon (KR)

(73) Assignee: DOOSAN CORPORATION, Seoul (KR)

(21) Appl. No.: 15/506,166

(22) PCT Filed: Aug. 25, 2015
(86) PCT No.: PCT/KR2015/008869

§ 371 Date: Feb. 23, 2017

(30) Foreign Application Priority Data
Aug. 27, 2014 (KR) 10-2014-0112480

(51) Int. Cl. B66F 9/22; F15B 13/02; F15B 11/08; F15B 1/02; F15B 13/04

(52) U.S. Cl. CPC B66F 9/22; F15B 1/021; F15B 13/0401; F15B 11/08; F15B 13/024

(57) ABSTRACT

The present disclosure relates to a hydraulic circuit for a forklift, and more particularly, to a hydraulic circuit for a forklift which is capable of preventing an engine from being stopped due to surge pressure that instantaneously occurs when a lift cylinder reaches an end stroke and thus cannot be operated any further when the lift cylinder is extended. According to the hydraulic circuit for a forklift according to the exemplary embodiment of the present disclosure, which is configured as described above, the accumulator is provided on the hydraulic line through which the working fluid is provided to the lift cylinder, and as a result, the accumulator may quickly absorb surge pressure when the surge pressure is produced in the lift cylinder or the hydraulic line.

### TECHNICAL FIELD

The present disclosure relates to a hydraulic circuit for a forklift, and more particularly, to a hydraulic circuit for a forklift which is capable of preventing an engine from being stopped due to surge pressure that instantaneously occurs when a lift cylinder reaches an end stroke and thus cannot be extended any further.

### BACKGROUND ART

In general, a forklift is provided with a hydraulic system and an engine.

The hydraulic system includes a hydraulic pump, a control valve, and an actuator. The hydraulic pump is operated by power of the engine, and discharges a working fluid having pressure. The control valve controls a flow direction and a flow rate of the working fluid. The actuator is operated by the working fluid provided via the control valve. The actuator provided in the forklift includes a lift cylinder.

The engine generates power. Meanwhile, recently, due to a tendency for engine downsizing, an engine, which produces a lower output than an engine in the related art, tends to be mounted in a forklift having a capacity similar to that of a forklift in the related art.

When an operator manipulates an operation lever, a pilot signal is created by an operation of the operation lever. The pilot signal moves a spool of the control valve.

That is, if the operator intends to move a fork upward, the operator manipulates the operation lever to perform an upward operation. Therefore, the pilot signal corresponding to the upward movement of the fork is created, the control valve is opened by the pilot signal, the working fluid is provided to the lift cylinder, and as a result, the fork is finally moved upward.

Meanwhile, a stroke distance at which the lift cylinder is extended and retracted is limited, and an end stroke point, to which the lift cylinder is maximally extended, is present.

However, in some instances, the operator cannot recognize whether the lift cylinder reaches the end stroke. For example, the operator cannot recognize whether the lift cylinder reaches the end stroke when visibility of the lift cylinder is not ensured by the operator.

In some instances, the upward operation is continuously performed even though the lift cylinder has reached the end stroke as described above, and thus the upward movement of the lift cylinder is continuously required. In this case, because the lift cylinder is not extended any further but the working fluid is intended to be continuously supplied, surge pressure is produced as pressure in the lift cylinder is instantaneously and rapidly increased.

Meanwhile, an equilibrating device is installed in the hydraulic system in order to prevent pressure from being abnormally increased. A relief valve is provided as an example of the equilibrating device.

A set pressure to be limited is set to the relief valve, and the relief valve is opened when pressure in a corresponding hydraulic line reaches the set pressure to be limited, thereby draining the working fluid.

However, a physical period of time is required until the pressure in the hydraulic system comes into equilibrium after the relief valve is opened. Further, the surge pressure acts as a very high rapid load to the hydraulic pump.

In a typical situation, when a rapid load is applied to the hydraulic pump, the engine will be controlled to increase an output in order to cope with the load, and the relief valve is also opened to equilibrate the pressure in the hydraulic system.

However, in the case in which a rapid load is applied to the hydraulic pump as described above, the rapid load may be higher than the output of the engine, and in this case, there occurs a problem in that the engine becomes unstable, such as a case in which a rotational speed of the engine is rapidly decreased or the engine is stopped.

In particular, the lower the output of the engine, the more vulnerable the engine to the surge pressure.

The situation in which the engine is stopped due to the surge pressure will be described in a little more detail.

A relief pressure at which the relief valve is opened is converted into drive torque of the hydraulic pump. That is, impulse L caused by pressure that increases when the relief valve is opened may be considered as angular momentum of a crank shaft of the engine. The impulse L may be obtained by integrating drive torque τ with respect to time t.

$$τ = P \frac{Q}{2 π} \qquad [ Expression 1 ]$$

τ: Drive torque

P: Discharge pressure of hydraulic pump

Q: Discharge flow rate of hydraulic pump

L=∫ₜ₁^{t2}τ(t)dt [Expression 2]

L: Impulse

τ: Drive torque

t: Time

t1: Point in time at which impact occurs

t2: Point in time at which engine is stopped

Le=I·ω=∫ₜ₁^{t2}τ(t)dt [Expression 3]

Le: Impulse

I: Inertia moment

ω: Angular velocity τ: Drive torque

t: Time

In a case in which the impulse L, which occurs at a point in time at which the relief valve is opened, is higher than the angular momentum Le of the crank shaft of the engine, the rotational speed (rpm) of the engine is rapidly decreased or the engine is stopped.

Two solutions may be discussed to stabilize the engine against the impulse L.

The first solution is a method of increasing rotational inertial energy of the engine. It is possible to increase the angular momentum by increasing the mass of a flywheel or increasing the rotational speed of the engine. However, there is concern that the method of increasing the rotational inertial energy of the engine may cause deterioration in start performance, and degradation of fuel economy.

The second solution is a method of setting the set pressure of the relief valve to a lower level. However, even though it is possible to reduce the impulse L by decreasing the set pressure, there is concern that operating performance deteriorates because pressure of the working fluid supplied to the lift cylinder is decreased.

Therefore, there is a need for new solutions because the two known solutions cannot satisfactorily solve the problem that the engine becomes unstable due to the surge pressure.

### DISCLOSURE

### Technical Problem

Therefore, a technical problem to be solved by the present disclosure is to provide a hydraulic circuit for a forklift which is capable of preventing an engine from becoming unstable due to surge pressure when the surge pressure is produced in a lift cylinder.

Technical problems to be solved by the present disclosure are not limited to the aforementioned technical problem, and other technical problems, which are not mentioned above, may be clearly understood from the following descriptions by those skilled in the art to which the present disclosure pertains.

### Technical Solution

To solve the technical problem, a hydraulic circuit for a forklift according to an exemplary embodiment of the present disclosure includes: an engine 1 which produces power; a hydraulic pump 2 which is operated by the power so as to suck a working fluid from an oil tank 3 and discharge the working fluid; a control valve 4 which is connected to the hydraulic pump 2 through a first hydraulic line 11, and controls a flow rate and a flow direction of the working fluid discharged from the hydraulic pump 2; a lift cylinder 5 which is connected to the control valve 4 through a second hydraulic line 12, operated by the working fluid introduced through the second hydraulic line 12, and connected to the oil tank 3 through a third hydraulic line 13 so as to discharge the working fluid to the oil tank 3; a relief valve 6 which is formed on a hydraulic line that connects the second hydraulic line 12 and the third hydraulic line 13, has relief pressure set thereto, and is opened when abnormal high pressure higher than the relief pressure is formed in the second hydraulic line 12; and an accumulator 7 which is connected to the first hydraulic line 11 or the second hydraulic line 12, and absorbs surge pressure when the surge pressure is produced in the first hydraulic line 11 or the second hydraulic line 12.

In addition, a plurality of accumulators 7 may be provided, the plurality of accumulators 7 may be connected to the first hydraulic line 11 and the second hydraulic line 11, respectively, and any one of the plurality of accumulators 7 may absorb the surge pressure when the surge pressure is produced in the first and second hydraulic lines 11 and 12.

The accumulator 7 may absorb the surge pressure prior to a point in time at which the relief valve 6 is opened.

Free charge pressure of the accumulator 7 may be 10% to 20% of the relief pressure of the relief valve 6.

Other detailed matters of the exemplary embodiment are included in the detailed description and the drawings.

### Advantageous Effects

According to the hydraulic circuit for a forklift according to the exemplary embodiment of the present disclosure, which is configured as described above, the accumulator is provided on the hydraulic line through which the working fluid is provided to the lift cylinder, and as a result, the accumulator may quickly absorb surge pressure when the surge pressure is produced in the lift cylinder or the hydraulic line.

In addition, according to the hydraulic circuit for a forklift according to the exemplary embodiment of the present disclosure, the surge pressure has no effect on the hydraulic pump and the engine, and as a result, it is possible to prevent the engine from becoming unstable due to the surge pressure.

### DESCRIPTION OF DRAWINGS

FIG. 1 is a view illustrating relief pressure lines.

FIG. 2 is a view for explaining a hydraulic circuit for a forklift according to an exemplary embodiment of the present disclosure.

FIG. 3 is a view illustrating relief pressure lines after absorbing impact.

### DESCRIPTION OF MAIN REFERENCE NUMERALS OF DRAWINGS

1: Engine

2: Hydraulic pump

3: Oil tank

4: Control valve

5: Lift cylinder

5a, 5b: First and second ports

6: Relief valve

7: Accumulator

11, 12, 13: First, second, and third hydraulic lines

### [Best Mode]

Advantages and features of the present disclosure and methods of achieving the advantages and features will be clear with reference to exemplary embodiments described in detail below together with the accompanying drawings.

Hereinafter, exemplary embodiments of the present disclosure will be described in detail with reference to the accompanying drawings. It should be appreciated that the exemplary embodiments, which will be described below, are illustratively described to help understand the present disclosure, and the present disclosure may be variously modified to be carried out differently from the exemplary embodiments described herein. However, in the description of the present disclosure, the specific descriptions and illustrations of publicly known functions or constituent elements will be omitted when it is determined that the specific descriptions may unnecessarily obscure the subject matter of the present disclosure. In addition, to help understand the present disclosure, the accompanying drawings are not illustrated based on actual scales, but parts of the constituent elements may be exaggerated in size.

Meanwhile, the terms used in the description are defined considering the functions of the present disclosure and may vary depending on the intention or usual practice of a manufacturer. Therefore, the definitions should be made based on the entire contents of the present specification.

Like reference numerals indicate like elements throughout the specification.

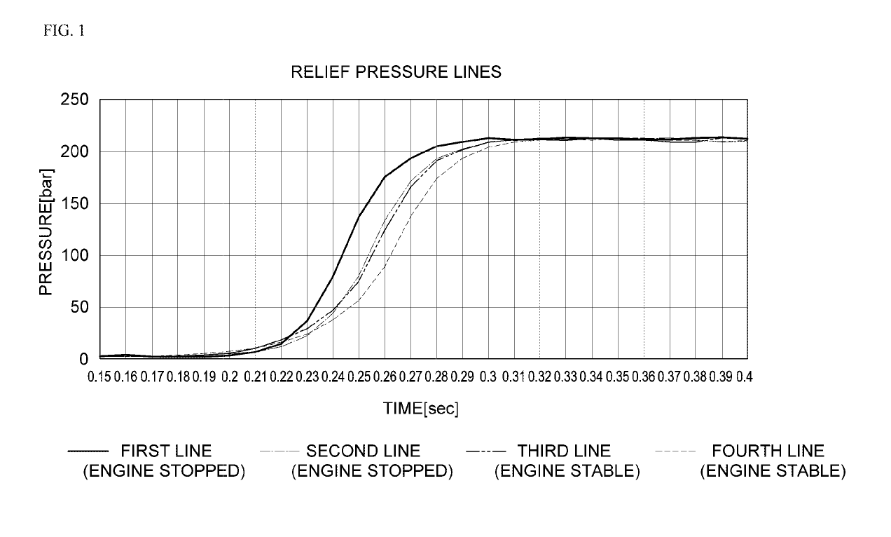

First, a correlation between relief pressure lines and an engine state will be described with reference to FIG. 1. The attached FIG. 1 is a view illustrating relief pressure lines.

The first line in FIG. 1, among the relief pressure lines, indicates that pressure is rapidly increased for a short period of time. In a case in which the relief pressure is increased as indicated by the first line, there occurs an unstable situation in which an engine is stopped.

In addition, the second line in FIG. 1 indicates that pressure is increased at a relatively more gradual speed in comparison with the first line. Even in a case in which the relief pressure is increased as indicated by the second line, there occurs an unstable situation in which a rotational speed of the engine is rapidly decreased.

Meanwhile, the third line in FIG. 1 indicates that pressure is increased at a relatively more gradual speed in comparison with the second line. In a case in which the relief pressure is increased as indicated by the third line, the rotational speed of the engine is not rapidly decreased but becomes stable.

Meanwhile, the fourth line in FIG. 1 indicates that pressure is increased at a relatively more gradual speed in comparison with the third line. In a case in which the relief pressure is increased as indicated by the fourth line, the rotational speed of the engine is excellently maintained and thus the engine becomes stable.

In addition, the second and third lines illustrated in FIG. 1 appear to be similar to each other, but are apparently different from each other in respect to the engine state when a speed at which the pressure increases is further decreased or increased. Referring to the relief pressure lines in FIG. 1, there are a first case in which surge pressure is produced and thus the engine is stopped (see the first and second lines), and a second case in which the engine is stable (see the third and fourth lines). The first case and the second case are different from each other in respect to the impulse by about 11%. That is, the second and third lines may be understood as critical lines of the relief pressure at which the engine may become stable.

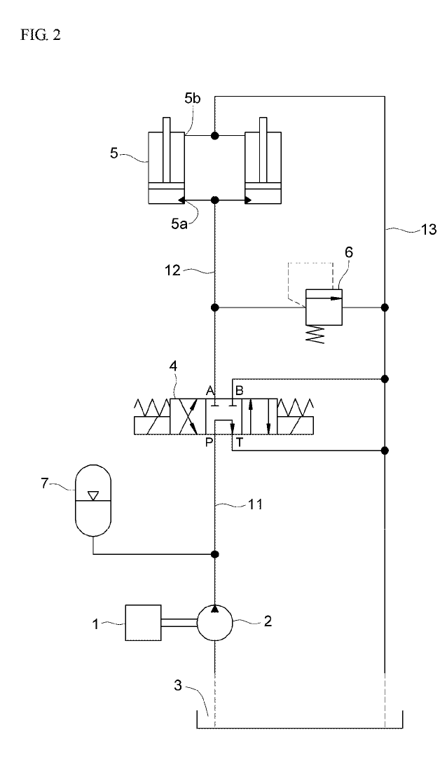

Hereinafter, the hydraulic circuit for a forklift according to the exemplary embodiment of the present disclosure will be described with reference to FIG. 2. The attached FIG. 2 is a view for explaining the hydraulic circuit for a forklift according to the exemplary embodiment of the present disclosure.

As illustrated in FIG. 2, in the hydraulic circuit for a forklift according to the present disclosure, an engine 1 and a hydraulic pump 2 are connected to each other, and the hydraulic pump 2 is operated by power produced from the engine 1.

The hydraulic pump 2 sucks a working fluid from an oil tank 3, and discharges the working fluid to a control valve 4. The hydraulic pump 2 and the control valve 4 are connected to each other through a first hydraulic line 11.

The control valve 4 moves a spool based on a pilot signal, thereby supplying the working fluid into a lift cylinder 5 or cutting off the supply of the working fluid. The control valve 4 and the lift cylinder 5 are connected to each other through a second hydraulic line 12. The lift cylinder 5 is provided with a head port 5a and a rod port 5b.

The pilot signal is a signal generated when an operator manipulates an operation lever. For example, when the operator manipulates the operation lever upward in order to move a fork upward, a corresponding pilot signal is generated so that the spool of the control valve 4 is operated in a direction in which the working fluid is supplied into the lift cylinder 5.

The lift cylinder 5 moves the fork upward and downward by using the provided working fluid. In a little more detail, when the head port 5a of the lift cylinder 5 and the control valve 4 are connected to each other and the working fluid is provided to the head port 5a, a rod of the lift cylinder 5 is extended, thereby moving the fork upward. In contrast, when the rod port 5b of the lift cylinder 5 and the control valve 4 are connected to each other and the working fluid is provided to the rod port 5b, the rod of the lift cylinder 5 is retracted, thereby moving the fork downward.

When the fork is moved upward, the working fluid in the lift cylinder 5 is discharged from the rod port 5b, and returns back to the oil tank 3. The rod port 5b of the lift cylinder 5 and the oil tank 3 are connected to each other through a third hydraulic line 13.

Meanwhile, the relief valve 6 is provided between the second hydraulic line 12 and the third hydraulic line 13. The relief pressure is set to the relief valve 6, thereby restricting pressure of the second hydraulic line 12. That is, in a case in which abnormal high pressure is formed in the second hydraulic line 12, the relief valve 6 is opened, and thus a part of the working fluid in the second hydraulic line 12 is discharged to the third hydraulic line 13, thereby maintaining constant pressure in the second hydraulic line 12.

Meanwhile, an accumulator 7 may be provided on the first hydraulic line 11 or the second hydraulic line 12. The accumulator 7 serves to absorb impact by absorbing the surge pressure before the relief valve 6 is opened.

In the case of the configuration in which the accumulator 7 is connected to the first hydraulic line 11, the accumulator 7 is disposed to be adjacent to the hydraulic pump 2, and as a result, it is possible to more quickly absorb the abnormal high pressure of the working fluid which is caused by the hydraulic pump 2. In addition, the accumulator 7 may absorb the surge pressure of the working fluid which may be produced when the control valve 4 is rapidly closed.

In the case of the configuration in which the accumulator 7 is connected to the second hydraulic line 12, the surge pressure may be produced at the moment when the lift cylinder 5 does not accommodate the working fluid any further, and the produced surge pressure may be absorbed.

Meanwhile, a plurality of accumulators 7 may be provided, and the accumulators 7 may be connected to the first hydraulic line 11 and the second hydraulic line 12, respectively. In the case in which the plurality of accumulators 7 is provided, it is possible to more quickly attenuate the surge pressure even when the surge pressure is suddenly produced at any one of the hydraulic pressure motor 2 and the lift cylinder 5 within a very short period of time.

Meanwhile, free charge pressure of the accumulator 7 may be 10% to 20% of the relief pressure of the relief valve 6. For example, if the relief pressure of the relief valve 6 is 250 bar, the free charge pressure of the accumulator 7 may be set to about 25 bar to 50 bar.

If the relief pressure of the relief valve 6 is 250 bar and the free charge pressure of the accumulator 7 is set to 35 bar, the accumulator 7 absorbs the surge pressure when the pressure formed in the first hydraulic line 11 or the second hydraulic line 12 is 35 bar to 240 bar.

Meanwhile, if the free charge pressure of the accumulator 7 is set to a too small degree, there is concern that hydraulic pressure operating performance may deteriorate, and if the free charge pressure of the accumulator 7 is set to a too high degree, there is concern that a point in time at which the surge pressure is absorbed is delayed, and thus the surge pressure cannot be absorbed at an appropriate point in time. Therefore, the free charge pressure of the accumulator 7 needs to be appropriately set with respect to the relief pressure of the relief valve 6.

When the free charge pressure of the accumulator 7 disclosed in the exemplary embodiment of the present disclosure is 10% to 20% of the relief pressure of the relief valve 6, the hydraulic pressure operating performance is excellent, and it is possible to excellently absorb the surge pressure at an appropriate point in time.

Hereinafter, an operation of the hydraulic circuit for a forklift according to the exemplary embodiment of the present disclosure will be described in detail.

First, the working fluid is supplied from the hydraulic pump 2, and the operator manipulates the operation lever, and as a result, the control valve 4 connects the first hydraulic line 11 and the second hydraulic line 12. The working fluid is provided to the lift cylinder 5 via the control valve 4, the lift cylinder 5 is operated by the provided working fluid, and finally, the fork of the forklift is operated.

When the operator still manipulates the lever in order to move the fork upward even in a case in which the fork has reached a position where the fork does not move upward any further during a process of moving the fork upward, that is, the cylinder has reached the end stroke, pressure in the lift cylinder 5 is instantaneously increased. Further, pressure in the first and second hydraulic lines 11 and 12 is also increased.

The relief valve 6 begins to be opened when the pressure in the hydraulic line, on which the relief valve 6 is installed, reaches the vicinity of the relief pressure, thereby discharging the working fluid to the oil tank 3. The relief valve 6 may begin to be opened from a point in time at which the pressure in the second hydraulic line 12 reaches a level of about 85% of the relief pressure.

A physical period of time is present from a point in time at which internal pressure of the lift cylinder 5 is formed as abnormal high pressure to a point in time at which the relief valve 6 begins to be opened. Even though the physical period of time may be a very short period of time, the accumulator 7 first absorbs pressure of the working fluid for the physical period of time before the relief valve 6 is opened.

In a little more detail, assuming that the relief pressure of the relief valve 6 is 240 bar, the surge pressure may be absorbed when the internal pressure of the lift cylinder 5 or the internal pressure of the first and second hydraulic lines 11 and 12 is about 25 bar to 240 bar because a magnitude of the free charge pressure of the accumulator 7 is 10% to 20% of a magnitude of the relief pressure of the relief valve 6. That is, the accumulator 7 may delay a rapid increase in pressure for a very short period of time, and may prevent instantaneous impact (surge or jerk) caused by a rapid increase in pressure from being transmitted to the engine.

Thereafter, when a position of the control valve 4 is changed to a neutral position or the operation lever is manipulated to move the fork downward after the relief valve 6 is opened, the working fluid accommodated in the accumulator 7 is discharged to the oil tank 3. Further, pressure of the accumulator 7 is decreased to the set pressure or lower.

The specifications of the accumulator 7 may be selected as a condition to be described below. The point in time at which the engine is stopped is determined in accordance with engine design specifications. As the engine design specifications, there are inertia moment I, an angular velocity ω of the crank shaft, and a reverse load (back-up torque). The engine design specifications may be measured through tests. An engine stop critical point value may be obtained by calculating angular momentum of the engine to the point in time at which the engine is stopped subsequently. The impulse which the accumulator 7 needs to absorb may be calculated by measuring impulse when the engine is stopped, and comparing the impulse with impulse at the engine stop critical point. That is, it is possible to select the specifications (operating pressure and a capacity) of the accumulator 7 based on the impulse which the accumulator needs to absorb.

L=∫ₜ₁^{t2}τ′(t)dt [Expression 4]

L: Impulse to be absorbed by accumulator

τ′: Torque to be absorbed by accumulator

t: Time

t1: Point in time at which impact occurs

t2: Point in time at which engine is stopped

τ′=P×Q [Expression 5]

τ′: Torque to be absorbed by accumulator

P: Discharge pressure of hydraulic pump

Q: Discharge flow rate of hydraulic pump

V=Q×n×t [Expression 6]

V: Volume of accumulator

Q: Discharge flow rate of hydraulic pump

n: Rotational speed of engine (rpm)

t: Time (s)

That is, the specifications of the accumulator 7 may be determined by Expressions 4, 5, and 6 as described above.

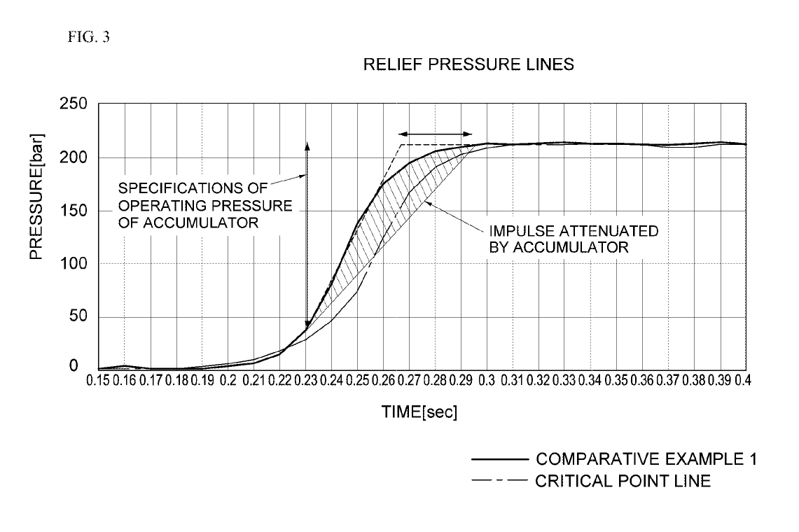

The attached FIG. 3 is a view illustrating relief pressure lines after absorbing impact. In FIG. 3, a line of Comparative Example 1 is a line that indicates a change in pressure when no accumulator is provided. In FIG. 3, a critical point line is a line that indicates a change in pressure at which the engine is not stopped and the rotational speed of the engine may be stably maintained.

According to the hydraulic circuit for a forklift according to the exemplary embodiment of the present disclosure, the accumulator 7 is configured to absorb the surge pressure prior to the point in time at which the relief valve 6 is opened. Therefore, the accumulator 7 may absorb the surge pressure from the point in time at which abnormal high pressure begins to be formed to the point in time at which the relief valve 6 begins to be opened, and as a result, it is possible to effectively prevent the surge pressure from adversely affecting the hydraulic pump 2 and the engine 1.

In addition, according to the hydraulic circuit for a forklift according to the exemplary embodiment of the present disclosure, the accumulator 7 absorbs the surge pressure before pressure in the hydraulic system reaches 85% of the relief pressure of the relief valve 6. Therefore, when abnormal high pressure begins to be formed, the accumulator 7 may more quickly absorb the surge pressure before the relief valve 6 is opened.

As described above, in a case in which the accumulators 7 are provided on the first and second hydraulic lines 11 and 12 in the hydraulic circuit for a forklift, it is possible to reduce an increase rate of pressure of the first and second hydraulic lines 11 and 12, and to prevent the engine from being stopped, as illustrated in FIG. 3. That is, since the accumulator 7 absorbs impulse, the engine is not stopped, and a stable state of the engine may be maintained.

While the exemplary embodiments of the present disclosure have been described with reference to the accompanying drawings, those skilled in the art will understand that the present disclosure may be implemented in any other specific form without changing the technical spirit or an essential feature thereof.

Accordingly, it should be understood that the aforementioned exemplary embodiment is described for illustration in all aspects and is not limited, and the scope of the present disclosure shall be represented by the claims to be described below, and it should be construed that all of the changes or modified forms induced from the meaning and the scope of the claims, and an equivalent concept thereto are included in the scope of the present disclosure.

### INDUSTRIAL APPLICABILITY

The hydraulic circuit for a forklift according to the exemplary embodiment of the present disclosure may be used to prevent the engine from being stopped due to the surge pressure.

1. A hydraulic circuit for a forklift, the hydraulic circuit comprising:
an engine which produces power;
a hydraulic pump which is operated by the power so as to suck a working fluid from an oil tank and discharge the working fluid;
a control valve which is connected to the hydraulic pump through a first hydraulic line, and controls a flow rate and a flow direction of the working fluid discharged from the hydraulic pump;
a lift cylinder which is connected to the control valve through a second hydraulic line, operated by the working fluid introduced through the second hydraulic line, and connected to the oil tank through a third hydraulic line so as to discharge the working fluid to the oil tank;
a relief valve which is formed on a hydraulic line that connects the second hydraulic line and the third hydraulic line, has relief pressure set thereto, and is opened when abnormal high pressure higher than the relief pressure is formed in the second hydraulic line; and
an accumulator which is connected to the first hydraulic line or the second hydraulic line, and absorbs surge pressure when the surge pressure is produced in the first hydraulic line or the second hydraulic line.

2. The hydraulic circuit of claim 1, wherein a plurality of accumulators is provided, the plurality of accumulators is connected to the first hydraulic line and the second hydraulic line, respectively, and any one of the plurality of accumulators absorbs the surge pressure when the surge pressure is produced in the first and second hydraulic lines.

3. The hydraulic circuit of claim 1, wherein the accumulator absorbs the surge pressure prior to a point in time at which the relief valve is opened.

4. The hydraulic circuit of claim 3, wherein free charge pressure of the accumulator is 10% to 20% of the relief pressure of the relief valve.

5. The hydraulic circuit of claim 2, wherein the accumulator absorbs the surge pressure prior to a point in time at which the relief valve is opened.

6. The hydraulic circuit of claim 5, wherein free charge pressure of the accumulator is 10% to 20% of the relief pressure of the relief valve.
